(19) United States
(12) Patent Application Publication
(10) Pub. No.: US 2006/0040146 A1
(43) Pub. Date: Feb. 23, 2006

(54) Liquid circulation type fuel cell and control method therefor

(75) Inventor: Atsushi Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/203,215

(22) Filed: Aug. 15, 2005

(30) Foreign Application Priority Data
Aug. 19, 2004 (JP) 2004-239234

(51) Int. Cl. H01M 8/00

(52) U.S. Cl. 429/12; 429/13; 429/17

(57) ABSTRACT

A liquid circulation type fuel cell generates electric power by circulating diluted liquid fuel to a fuel cell. In a dilution fuel cell system of circulation type, a decompression mechanism for reducing the pressure in a dilution fuel tank for circulating the diluted fuel for the fuel cell is provided. Thereby gas in the dilution fuel tank is removed. With this, the operational failure of the circulation pump caused by the gas in the diluted fuel can be avoided, enabling stable operation of the fuel cell system.

### CROSS-REFERENCE TO RELATED APPLICATIONS

This application is based upon and claims the benefit of priority from the prior Japanese Patent Application No. 2004-239234, filed on Aug. 19, 2004, the entire contents of which are incorporated herein by reference.

### BACKGROUND OF THE INVENTION

1. Field of the Invention

The present invention relates to a liquid circulation type fuel cell, and a control method therefor, for generating electric power through reaction between the liquid fuel and gas, and more particularly a liquid circulation type fuel cell, and a control method therefor, suitable for use as power source for an electronic apparatus.

2. Description of the Related Art

With the development of electronic apparatuses in recent years, there have been an increased number of apparatuses including portable electronic devices which are driven by batteries. Among such batteries, a fuel cell, particularly a liquid circulation type fuel cell, attracts attention.

The liquid circulation type fuel cell uses a substance capable of permeating protons or electrons (such as a polymer electrolyte membrane), and has a structure of disposing liquid fuel (such as aqueous solution of methanol) including the hydrogen component on one side (fuel pole side), and a substance (such as air) including the oxygen component on the other side (air pole side). The substance (such as a polymer electrolyte membrane) through which protons or electrons are permeable can permeate hydrogen protons in the liquid fuel, and makes the hydrogen protons combined with oxygen in the substance (such as air) including oxygen. At this time, the remainder of electrons among the hydrogen in the liquid fuel can be extracted as electricity, which functions as battery.

FIGS. 7 and 8 show explanation diagrams of the prior art. As shown in FIG. 7, a fuel cell 200 has an air pole 202 and a fuel pole 204, with an electrolyte membrane 206 sandwiched therebetween. Air is supplied from an air blower 210 to the air pole 202, while the liquid fuel is supplied to the fuel pole 204.

When methanol is used as the liquid fuel, through the reaction between the hydrogen and the oxygen, water (vapor) is generated on the air pole 202 side. Also, on the fuel pole 204 side, the methanol is dissolved and carbon dioxide is generated. For example, in this fuel cell, assuming ideal chemical change and electric power generation are performed by making 1 mol of methanol and 1 mol of water consumed on the fuel pole 204 side, and also 1 mol of oxygen consumed on the air pole 202 side, after the power generation, approximately 3 mol of water is generated on the air pole 202 side, and also approximately 1 mol of the carbon dioxide is generated on the fuel pole 204 side.

The vapor at the air pole 202 is led to a recovery tank 240, and collected as water. Further, in this fuel cell, an amount of methanol per unit area of electrolyte membrane 206 can be increased by the use of highly concentrated fuel. With this, an improved electromotive force can be expected, as well as a size reduction of a fuel tank. However, in the polymer electrolyte membrane 206 constituting the fuel cell, when using highly concentrated methanol, a counter-electromotive force tends to be produced. Also from the viewpoint of lifetime, generally, it is most appropriate to supply the fuel of 1 mol concentration to the fuel cell.

For this reason, such a highly concentrated fuel is supplied from a liquid fuel tank 230 to a dilution fuel tank 220 by use of a fuel supply pump 234. The fuel is diluted with water in the dilution fuel tank 220, and the diluted fuel is supplied to the fuel pole 204 by means of a fuel circulation pump 226. This water for dilution is obtained by returning the water from the recovery tank 240 to the dilution fuel tank 220 via a water supply pump 242.

Meanwhile, the carbon dioxide (CO₂) generated at the fuel pole 204 is collected to the dilution fuel tank 220, together with the diluted fuel having not been consumed at the fuel pole 204. An exemplary process of the fuel cell cycle is disclosed in Japanese Laid-open Patent Publication No. 2003-297401. As shown in FIG. 8, the liquid level in the dilution fuel tank 220 is measured using a liquid level sensor 224. If the liquid level is lower than a reference level, then a water supply pump 242 and a fuel supply pump 234 are driven to supply the fuel of the liquid fuel tank 230 and the water to the dilution fuel tank 220. Further, depending on the condition of a concentration sensor 222 in the dilution fuel tank 220, the fuel supply pump 234 and the water supply pump 242 are controlled.

In such a fuel dilution system, since the carbon dioxide generated at the fuel pole 204 is generated in the liquid fuel, it is difficult to separate. For this reason, to avoid wasted use of the liquid fuel and to reuse the liquid fuel, the liquid fuel including the carbon dioxide is collected into the dilution fuel tank 220, and the carbon dioxide is exhausted therefrom.

However, the carbon dioxide generated at the fuel pole 204 is formed of fine bubbles, and therefore it is difficult to discharge by separating the carbon dioxide from the water in the dilution fuel tank 220. Namely, because of the fine bubble shape of the carbon dioxide, when the carbon dioxide flowing into the dilution fuel tank 220 is mixed with the diluted fuel, it is difficult to separate from water and exhaust externally. For example, although a portion of the carbon dioxide is separated and exhausted by natural emission, other portions of the carbon dioxide bubble cannot be separated, and remain in the diluted fuel.

Meanwhile, circulation pump 226 performs a role of supplying the diluted fuel from the dilution fuel tank 220 to the fuel pole 204, as well as returning the diluted fuel from the fuel pole 204 to the dilution fuel tank 220. When a low-cost pump having an impeller as pump 226 is used for circulating the diluted fuel between the fuel cell 200 and the dilution fuel tank 220, the carbon dioxide bubbles in the diluted fuel remained are stirred by the impeller, and combined into larger bubbles because of the surface tension. As a result, the gas is sucked into pump 226, which causes a trouble of disabling pump 226 from circulating the liquid fuel. Particularly, when the pump is miniaturized, the deaeration performance of the dilution fuel tank is damaged.

Moreover, since it is necessary to control a multiplicity of sensors and pumps for supplying the liquid fuel and the water, substantial power generated by the fuel cell is wasted in the above control.

### SUMMARY OF THE INVENTION

Accordingly, it is an object of the present invention to provide a liquid circulation type fuel cell, and a control method therefor, so as to avoid a trouble in the liquid fuel circulation by performing deaeration of the diluted fuel.

It is another object of the present invention to provide a liquid circulation type fuel cell, and a control method therefor, so as to avoid a trouble in the liquid fuel circulation even in a miniaturized liquid fuel cell.

It is still another object of the present invention to provide a liquid circulation type fuel cell, and a control method therefor, so as to reduce the number of power pumps and the amount of power consumption even when performing deaeration of the diluted fuel.

It is still another object of the present invention to provide a liquid circulation type fuel cell, and a control method therefor, so as to avoid a trouble in the liquid fuel circulation without evaporating necessary water in the dilution fuel tank.

In order to attain the aforementioned objects, a liquid circulation type fuel cell according to the present invention includes: a fuel cell generating electric power using liquid fuel; a dilution fuel tank retaining diluted fuel having the liquid fuel mixed with water; a dilution fuel circulation path at least having a circulation pump circulating the diluted fuel to the fuel cell; a water supply tank supplying the water to the dilution fuel tank; a fuel supply tank supplying the liquid fuel to the dilution fuel tank; and a decompression mechanism reducing the pressure in the dilution fuel tank to remove vapor.

According to the present invention, a control method for a liquid circulation type fuel cell includes: a step of circulating diluted fuel from a dilution fuel tank retaining the diluted fuel having the liquid fuel mixed with water, to a fuel cell for generating power using the liquid fuel, via a dilution fuel circulation path at least having a circulation pump; a water and fuel supply step of supplying the water or the liquid fuel to the dilution fuel tank either from a water tank retaining the water or a fuel tank retaining the liquid fuel; and a decompression step of reducing pressure in the dilution fuel tank and removing vapor by means of a decompression mechanism.

Further, according to the present invention, preferably valves for controlling supply operation are respectively provided on the dilution fuel circulation path, a first supply path connecting the water supply tank with the dilution fuel tank, and a second supply path connecting the fuel supply tank with the dilution fuel tank.

Still further, according to the present invention, preferably a controller is provided for shutting off either one of the valves on the first supply path and the second supply path, and for driving the decompression mechanism.

Further, according to the present invention, preferably the controller opens either one of the valves on the first supply path and the second supply path, and drives the decompression mechanism to supply the water or the liquid fuel to the dilution fuel tank.

Further, according to the present invention, preferably the controller detects a fuel concentration in the dilution fuel tank, opens either one of the valves on the first supply path and the second supply path according to the detected concentration, and drives the decompression mechanism to supply the water or the liquid fuel to the dilution fuel tank.

Further, according to the present invention, preferably the decompression mechanism includes a valve connected to the dilution fuel tank and a decompression pump connected to the valve.

Further, according to the present invention, preferably the controller circulates the diluted fuel between the dilution fuel tank and the fuel cell by opening the valve on the dilution fuel circulation path, driving the circulation pump, and shutting off each valve on the first supply path and the second supply path.

Further, according to the present invention, preferably the fuel cell includes: an electrolyte membrane; a fuel pole supplying the diluted fuel on one side of the electrolyte membrane; and an oxygen pole supplying an oxidizing agent including oxygen on the other side of the electrolyte membrane.

Further, according to the present invention, preferably the electrolyte membrane includes a permeable membrane formed of a substance capable of permeating protons or electrons.

Still further, according to the present invention, preferably the controller drives the decompression mechanism at a predetermined period.

Further scopes and features of the present invention will become more apparent by the following description of the embodiments with the accompanied drawings.

### BRIEF DESCRIPTION OF THE DRAWINGS

FIG. 1 shows a configuration diagram of a liquid circulation type fuel cell according to an embodiment of the present invention.

FIG. 2 shows a configuration diagram of the liquid fuel cell shown in FIG. 1.

FIG. 3 shows a configuration diagram of an electronic apparatus to which the liquid fuel cell shown in FIG. 1 is applied.

FIG. 4 shows a control process flowchart of the liquid fuel cell shown in FIG. 1.

FIG. 5 shows a process flowchart of a fuel supply cycle shown in FIG. 4.

FIG. 6 shows a process flowchart of a water supply cycle shown in FIG. 4.

FIG. 7 shows a configuration diagram of a conventional liquid circulation fuel cell.

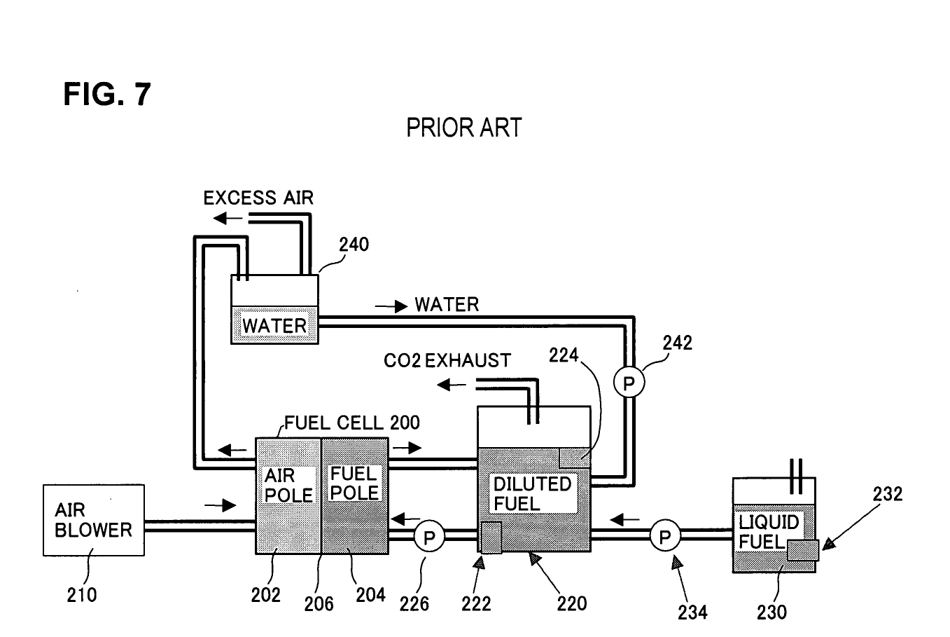

FIG. 8 shows an explanation diagram of a conventional liquid circulation fuel cell.

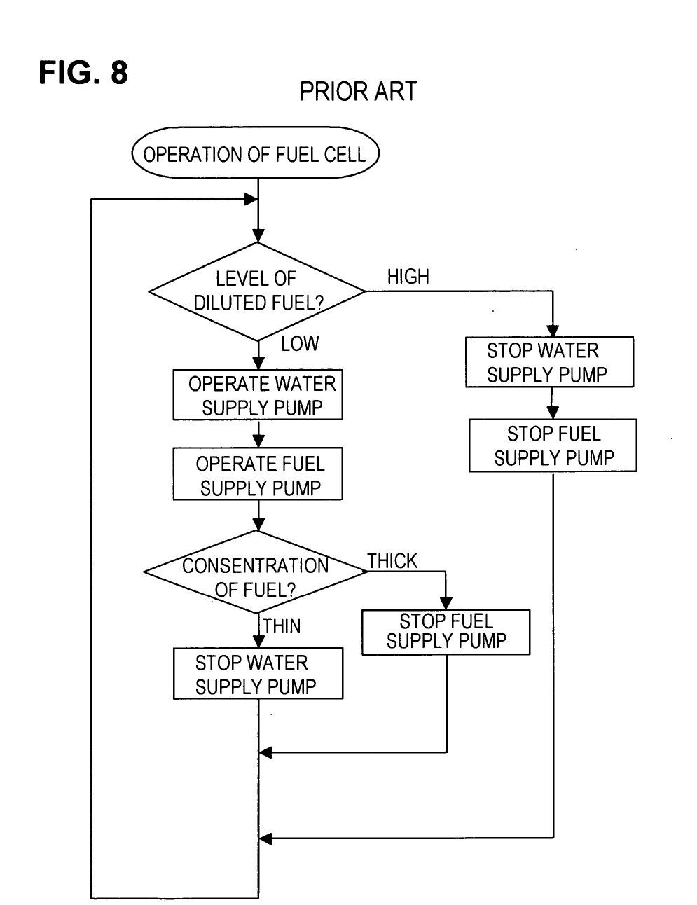

### DETAILED DESCRIPTION OF THE INVENTION

The preferred embodiments of the present invention are described hereinafter, referring to the charts and drawings, in order of a liquid circulation type fuel cell, a control method for liquid circulation type fuel cell, and other embodiments.

Liquid Circulation Type Fuel Cell

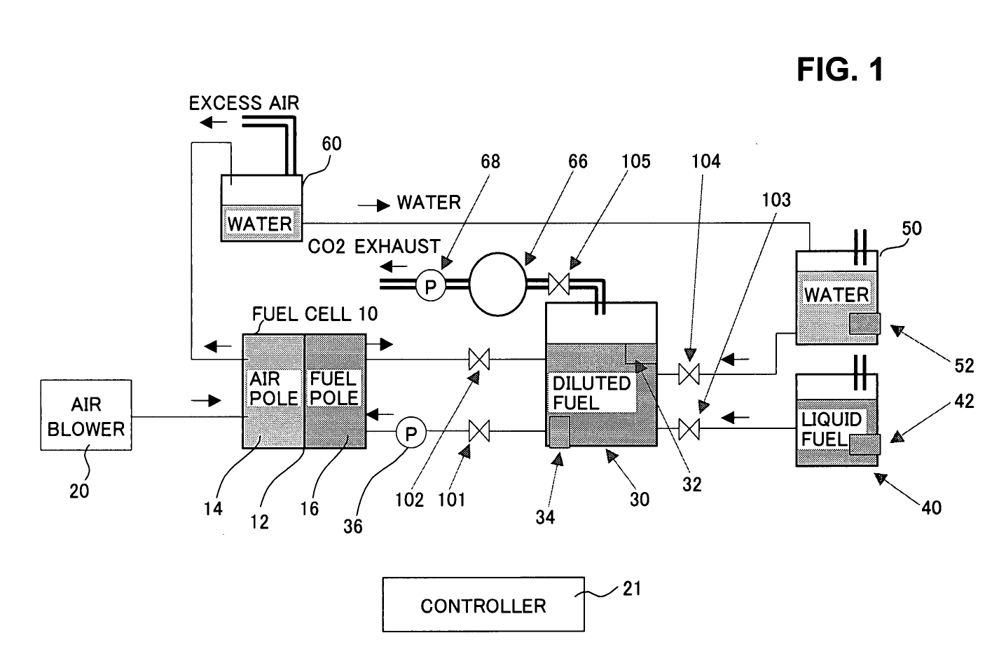

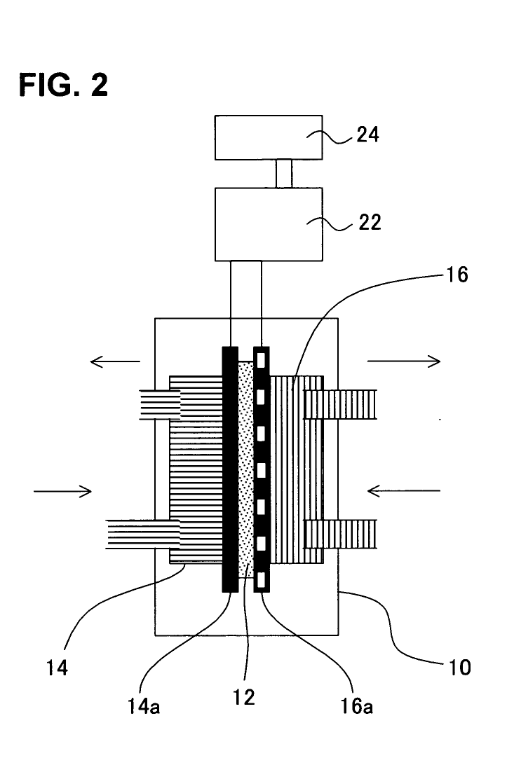

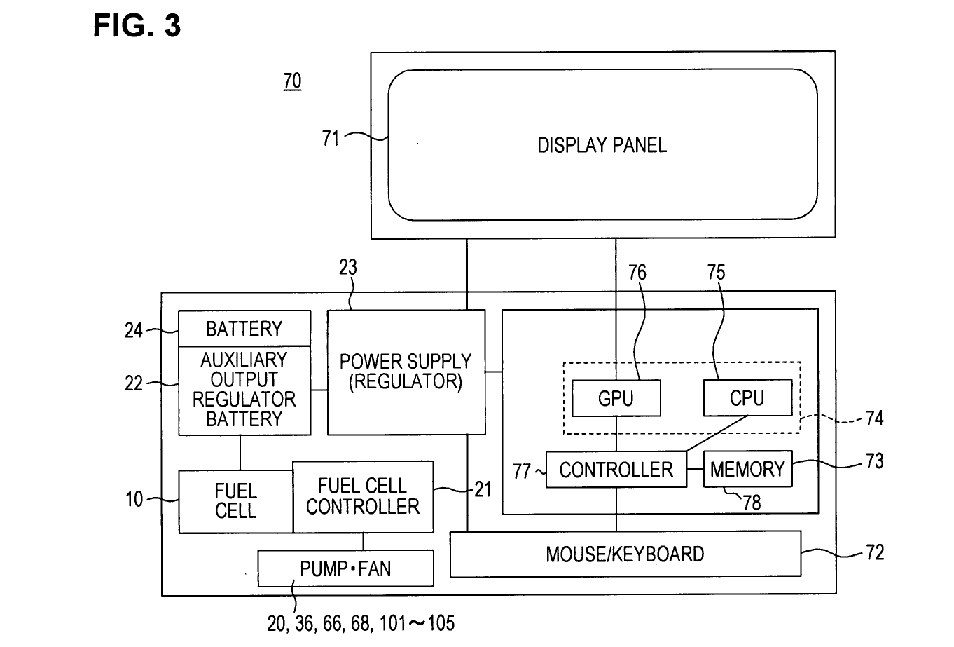

FIG. 1 shows a configuration diagram of a liquid circulation type fuel cell according to a first embodiment of the present invention. FIG. 2 shows a configuration diagram of the liquid fuel cell shown in FIG. 1. Further, FIG. 3 shows a configuration diagram of an electronic apparatus, in which the liquid fuel cell shown in FIG. 1 is applied, as one example. As shown in FIG. 1, a fuel cell 10 includes an electrolyte membrane 12, and also, an air pole 14 and a fuel pole 16 sandwiching electrolyte membrane 12. As shown in FIG. 2, the electrolyte membrane 12 is constituted of a substance capable of permeating protons or electrons, such as a polymer electrolyte membrane, including a proton-conductive solid polymer membrane like Nafion (brand mark of DuPont.Ltd) of perfluorosulphonic acid. On both sides of the electrolyte membrane 12, fuel electrode 16a and an oxidant electrode 14a are disposed, thereby constituting an electrolyte plate.

Air is supplied to the air pole 14 which includes the oxidant electrode 14a by an air blower 20, while liquid fuel is supplied to the fuel pole 16 which includes the fuel electrode 16a. An electromotive force generated between both the electrodes 14a, 16a is supplied to each load via an auxiliary output regulator 22 connected to a battery 24. Or, the electromotive force charges the battery 24.

When methanol is used as liquid fuel, water (vapor) is generated on the air pole 14 side through the reaction between hydrogen and oxygen mediated by a proton catalyst of the electrolyte membrane 12. Also, on the fuel pole 16 side, the methanol is dissolved, and thereby carbon dioxide of bubble shape is generated. For example, in this fuel cell, assume that chemical change and power generation are ideally performed by making 1 mol of methanol and 1 mol of water consumed on the fuel pole 16 side, and also making 1 mol of oxygen consumed on the air pole 14 side. After the power generation, approximately 3 mol of the water is generated on the air pole 14 side, while approximately 1 mol of the carbon dioxide is generated on the fuel pole 16 side.

A water recovery tank 60 performs natural cooling against the vapor from the air pole 14 and collects as water, while exhausting excess air. Further, using highly concentrated fuel in the fuel cell, an amount of the methanol per unit area of the electrolyte membrane 12 can be increased. With this, an improved electromotive force can be expected, and also the fuel tank can be reduced in size. However, in the polymer electrolyte membrane 12 constituting the fuel cell, if the methanol is highly concentrated, a counter-electromotive force tends to be produced. Also from the viewpoint of lifetime, generally, it is most appropriate to supply the fuel of 1 mol concentration to the fuel cell.

For this purpose, the fuel of high concentration is supplied from a liquid fuel tank 40 to a dilution fuel tank 30, by means of a fuel valve 103. In the dilution fuel tank 30, the fuel is diluted by the water, and supplied to the fuel pole 16 by means of a fuel valve 101 and a fuel circulation pump 36. The above water for dilution is obtained by returning the water from the water collection tank 60 to a water supply tank 50, and by returning the water in the water supply tank 50 to the dilution fuel tank 30 via a water valve 104.

Meanwhile, the carbon dioxide (CO₂) generated at the fuel pole 16 is collected to the dilution fuel tank 30 together with the diluted fuel which has not been consumed at the fuel pole 16, via a circulation valve 102 disposed on the circulation pipe.

Further, a decompression mechanism is provided for the purpose of reducing the pressure in the dilution fuel tank 30, separating and exhausting the carbon dioxide bubbles in the diluted fuel of the dilution fuel tank 30. Namely, on a gas emission path disposed in the upper position of the dilution fuel tank 30, a decompression valve 105, a chamber 66 and a decompression pump 68 are provided.

With these decompression mechanisms 105, 66, 68, the pressure in the dilution fuel tank 30 is reduced, by which the gas tends to be emitted. In particular, gas bubbles in the diluted fuel spout from the diluted fuel as a result of the decompression, which makes it effective to eliminate carbon dioxide, etc. in the diluted fuel.

Moreover, the valves 101-104 perform a role of shutting off the dilution fuel tank 30 from outside at the time of decompression (deaeration). Moreover, the valves 103, 104 respectively perform operation control for supplying fuel and water.

More specifically, in order to work the fuel cell system normally, the remove of gas operation is performed periodically at such intervals as preventing the gas from being retained in the fuel circulation pump 36. In a cycle when the remove of gas operation is performed, the entire valves 101-104 are closed, except for valve 105 directed to decompression pump 68 and chamber 66. Namely, this valve 105 is kept open. Through the operation of decompression pump 68, the pressure in the dilution fuel tank 30 is reduced, and the remove of gas is performed accordingly.

After the remove of gas is completed, the decompression pump 68 is halted and the valve 105 is shut off. Also, the valves 101, 102 and the circulation pump 68 for fuel circulation are driven. By remaining the valve 105 directed to the decompression pump 68 open, natural emission of the carbon dioxide generated in the fuel cell can be made even in other cycles than the remove of gas operation cycle. Here, when the valve 105 is used in a continuous open state, consideration becomes necessary so as not to leak the fuel.

Except for the remove of gas operation cycle, the decompression pump 68 can be used for supply fuel or water. Namely, similar to shutting off the valves in the remove of gas (decompression) cycle, the valves 101-104 are once closed, and the decompression pump 68 is driven. At this time, by opening each the valve 103, 104 in order to supply either the fuel or the water, it becomes possible to use the decompression pump 68 as a pump for supplying the fuel or the water.

These valves 101-105 require power only at the time of open or shutoff operation. Further, these valves are of rotation drive like a pump, no power is required in steady states. By the above means, the remove of the gas in the diluted fuel can be performed, and occurrence of an operational failure in the fuel cell system can be prevented. Moreover, by reducing the number of pumps to be driven, the power efficiency of the fuel cell system can be improved.

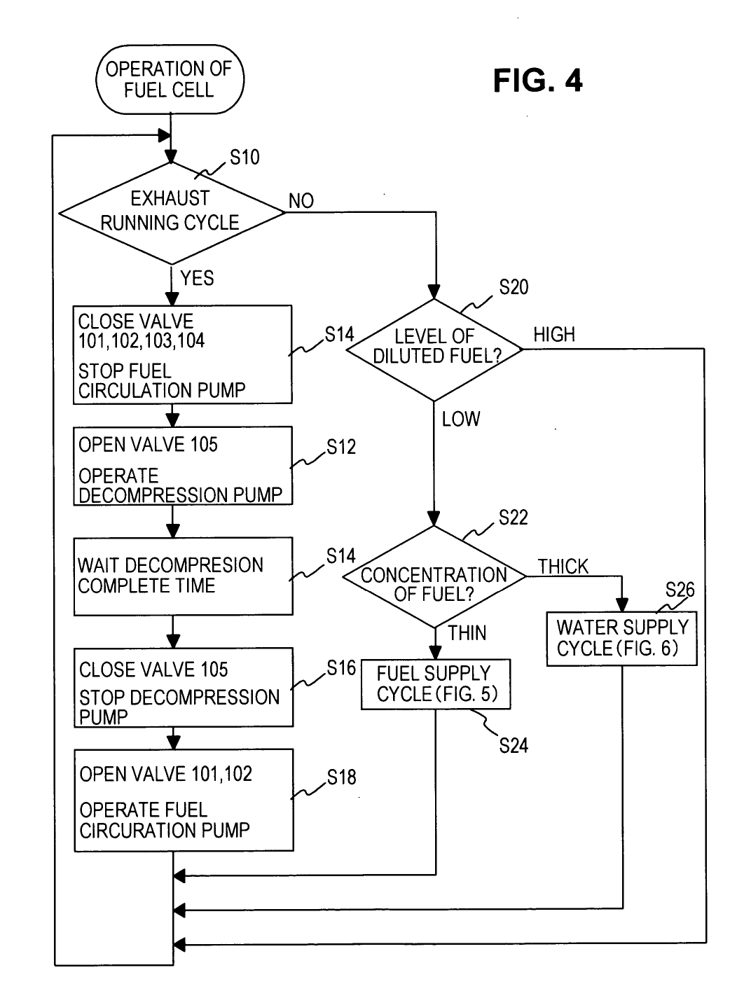

In addition, liquid level sensors 52, 42 and 32 are provided in the water supply pump 50, the fuel supply tank 40 and the dilution fuel tank 30, respectively. Further, in the dilution fuel tank 30, a fuel densitometer 34 is provided. A fuel cell controller 21 monitors the measured output of each liquid level sensor 52, 42, 32 and the fuel densitometer 34, and controls the operation of each valve 101-105, the fuel circulation pump 36, the decompression pump 68, according to the remove of gas operation cycle, the fuel supply cycle, and the water supply cycle. The detail of these cycles will be described later in FIGS. 4 through 6.

Also, since the water from the water recovery tank 60 has relatively high temperature, by providing a system for once retaining in the water supply tank 50 the water collected in the water recovery tank 60, and thereafter supplying this to the dilution fuel tank 30, evaporation of the water in the dilution fuel tank 30 can substantially be prevented.

FIG. 3 shows an example of an apparatus to which the liquid fuel cell shown in FIG. 1 is applied. In this example, the liquid fuel cell is applied to a personal computer (mobile personal computer). A personal computer (PC) 70 includes display panel 71, circuit board 73 and mouse/keyboard 72. Circuit board 73 is provided with various types of memories 78, controller 77, and also motherboard 74 having CPU 75 and GPU (graphic processor unit) 76 mounted thereon.

Further, PC 70 includes the aforementioned fuel cell 10, the fuel cell controller 21, various kinds of pumps and fan 20, 36, 66, 68, 101-105, the auxiliary output regulator 22, the battery 24, and the power supply (regulator) 23. The power is supplied from the power supply 23 to the mouse/keyboard 72, the circuit board 73 and the display panel 71.

Control Method of Liquid Fuel Cell

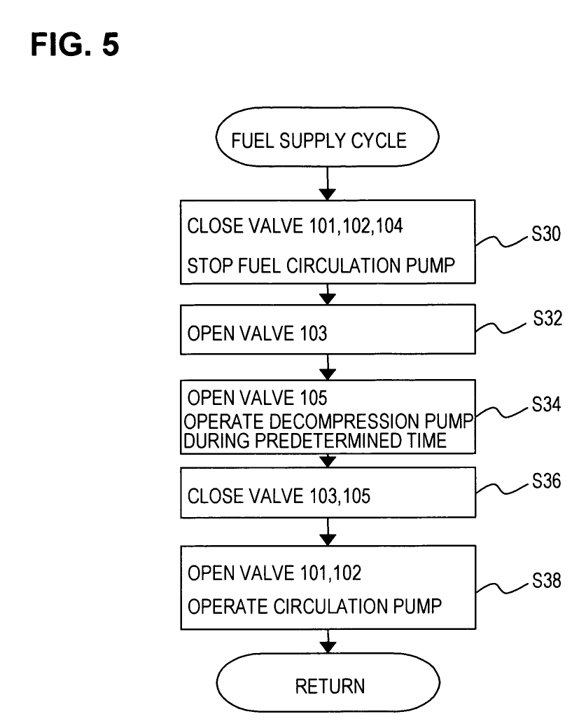

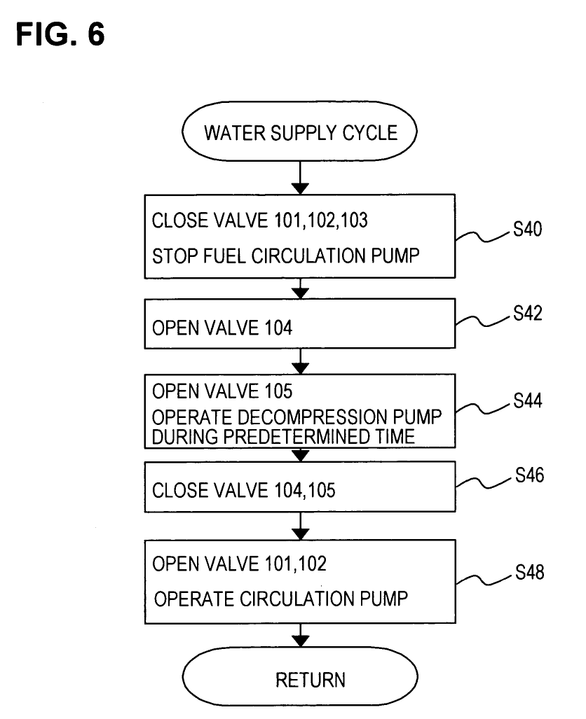

Next, a control method of the fuel cell system of the configuration shown in FIG. 1 is described hereafter. FIGS. 4 through 6 show flowcharts of fuel cell control processing executed by the aforementioned controller 21. FIG. 4 shows an overall control process flowchart of the liquid fuel cell shown in FIG. 1, and FIG. 5 shows a process flowchart of a fuel supply cycle shown in FIG. 4, and further, FIG. 6 shows a process flowchart of a water supply cycle shown in FIG. 4. Hereafter, referring to FIGS. 5, 6, explanation will be given for the remove of gas operation process, which is periodically performed at such intervals as preventing gas from being retained in the fuel circulation pump 36, in order to ensure normal operation of the fuel cell.

(S10) The controller 21 decides whether the current cycle is the remove of gas operation cycle. Here, because the remove of gas operation is performed at a certain period, whether it is a remove of gas operation time corresponding to a predetermined period is decided.

(S12) When the controller 21 decides to be the remove of gas operation cycle, as to the valves 101-105 connected to the dilution fuel tank 30, the controller 21 shuts off the entire valves 101-104, excluding the valve 105 connected to the decompression pump 68, and also halts the circulation pump 36.

(S14) Next, controller 21 opens valve 105 connected to decompression pump 68, and drives the decompression pump 68. With this, the pressure in the dilution fuel tank 30 is reduced, and the remove of gas is performed. Here, because the above decompression may undesirably cause intake of the fuel in the dilution fuel tank 30 when the capacity of the dilution fuel tank 30 is substantially small, the chamber 66 functions as a buffer for the internal gas. The above operation is performed for the predetermined decompression time duration, and accordingly, the controller 21 waits for completion of the decompression time.

(S16) When the remove of gas (i.e. after a lapse of the decompression time) is completed, the controller 21 halts the decompression pump 68, and shuts off the valve 105.

(S18) Next, the controller 21 opens valves 101, 102 for fuel circulation, and drives the circulation pump 36. With this, the circulation of the diluted fuel between the dilution fuel tank 30 and the fuel pole 16 is started, thus enabling power generation. Then, the process returns to step S10.

(S20) Meanwhile, in step S10, when the controller 21 decides to be not the remove of gas operation cycle, the controller 21 measures the liquid level of the dilution fuel tank 30 using the liquid level sensor 32, and decides whether the liquid level is higher, or lower, than a reference level. When the liquid level is higher, there is no need of supplying both fuel and water, and the process returns to step S10.

(S22) Meanwhile, on deciding that the liquid level being lower than the reference level, the controller 21 detects a concentration in the dilution fuel tank 30, which is measured by the fuel densitometer 34, and decides whether the concentration is higher, or lower, than a reference level.

(S24) When the concentration is lower than the reference level, the controller 21 performs the fuel supply cycle process shown in FIG. 5. Thereafter, the process returns to step S10.

(S26) On the other hand, when the concentration is higher than the reference level, the controller 21 performs the water supply cycle process shown in FIG. 6. Thereafter, the process returns to step S10.

Next, referring to FIG. 5, the above-mentioned fuel supply cycle process is described below.

(S30) Among the valves 101-105 connected to the dilution fuel tank 30, the controller 21 shuts off the valves 101, 102 and 104, except for the valve 103 connected to the fuel tank 40. The controller 21 also halts the circulation pump 36.

(S32) Next, the controller 21 opens the valve 103 connected to the fuel tank 40. With this, it becomes possible to supply the liquid fuel from the fuel tank 40 to the dilution fuel tank 30.

(S34) The controller 21 then opens the valve 105 connected the decompression pump 68, and drives the decompression pump 68 for a certain time period. With this, the decompression pump can be used as fuel supply pump.

(S36) Next, the controller 21 shuts off the valves 103, 105. With this, supply of the liquid fuel is stopped.

(S38) Subsequently, the controller 21 opens the valves 101, 102 for circulating the fuel, and drives the circulation pump 36. With this, circulation of the diluted fuel between the dilution fuel tank 30 and the fuel pole 16 is started, enabling power generation operation. The process then returns to step S10.

Next, referring to FIG. 6, the aforementioned water supply process is described below.

(S40) With regard to the valves 101-105 connected to the dilution fuel tank 30, the controller 21 shuts off the valves 101, 102 and 103, except for the valve 104 connected to the water supply tank 50. The controller 21 also halts the circulation pump 36.

(S42) Next, the controller 21 opens the valve 104 connected to the water supply tank 50. This enables supply of water from the water supply tank 50 to the dilution fuel tank 30.

(S44) The controller 21 then opens the valve 105 connected to the decompression pump 68, and drives the decompression pump 68 for a certain time period. With this, it becomes possible to use the decompression pump as water supply pump.

(S46) Next, the controller 21 shuts off the valves 104, 105. With this, the water supply is stopped.

(S48) Subsequently, the controller 21 opens the valves 101, 102 for fuel circulation, and drives the circulation pump 36. With this, circulation of the diluted fuel between the dilution fuel tank 30 and the fuel pole 16 is performed, enabling power generation operation. Then, the process returns to step S10.

As such, remove of the gas in the diluted fuel becomes possible, and thus occurrence of an operational failure in the fuel cell system can be prevented. Further, by reducing the number of pumps to be driven, power efficiency of the fuel cell system can be improved.

### Other Embodiments

Although the methanol aqueous solution is used as liquid fuel in the aforementioned embodiment, it is not necessarily limited to the methanol aqueous solution. It is also possible to use a hydrocarbon such as dimethylether, diethylether, cyclohexane, etc. or alkaline solution of sodium borohydride, sodium tetrahydroborate (NaBH₄), etc.

Further, as oxidizing agent, either air or oxygen in the air has been used in the above description. However, the oxidizing agent is not limited to the above. Instead, using hydrogen peroxide (H₂O₂) water, oxygen generated by the dissolve reaction of peroxidation may also be applicable.

Further, in the foregoing description, the electrolyte membrane is explained as a membrane capable of permeating protons. However, the electrolyte membrane may be configured of a membrane capable of permeating electrons. In addition, although a personal computer is exemplified in the foregoing description as electronic apparatus, it is possible to apply the method according to the present invention to other portable electronic apparatuses such as portable telephone, and a motion robot, a toy, etc.

Also, in the configuration shown in FIG. 1, when necessary, it is possible to omit the water supply tank 50, and adopt a system in which water is supplied from the water recovery tank 60 to the dilution fuel tank 30.

To summarize the effects of the present invention, in a dilution fuel cell system of circulation type, by providing a decompression mechanism for decompressing the pressure in the dilution fuel tank, remove of the gas in the diluted fuel becomes possible. Thus, occurrence of an operational failure of the pumps caused by the gas in the diluted fuel can be prevented, and stable operation of the fuel cell system can be attained.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A liquid circulation type fuel cell comprising:
a fuel cell for generating electric power using liquid fuel;
a dilution fuel tank for retaining diluted fuel having the liquid fuel mixed with water;
a dilution fuel circulation path at least having a circulation pump for circulating the diluted fuel to the fuel cell;
a water supply tank for supplying water to the dilution fuel tank;
a fuel supply tank for supplying the liquid fuel to the dilution fuel tank; and
a decompression mechanism for reducing the pressure in the dilution fuel tank to remove gas.

2. The liquid circulation type fuel cell according to claim 1,
wherein further comprises valves for controlling supply operation and respectively provided on the dilution fuel circulation path, a first supply path connecting the water supply tank with the dilution fuel tank, and a second supply path connecting the fuel supply tank with the dilution fuel tank.

3. The liquid circulation type fuel cell according to claim 2,
wherein further comprises a controller for shutting off either one of the valves on the first supply path and the second supply path and for driving the decompression mechanism.

4. The liquid circulation type fuel cell according to claim 3,
wherein the controller opens either one of the valves on the first supply path and the second supply path and drives the decompression mechanism for supplying the water or the liquid fuel to the dilute fuel tank.

5. The liquid circulation type fuel cell according to claim 4,
wherein the controller detects a fuel concentration in the dilution fuel tank, opens either one of the valves on the first supply path and the second supply path according to the detected concentration, and drives the decompression mechanism for supplying the water or the liquid fuel to the dilute fuel tank.

6. The liquid circulation type fuel cell according to claim 1,
wherein the decompression mechanism comprises a valve connected to the dilution fuel tank and a decompression pump connected to the valve.

7. The liquid circulation type fuel cell according to claim 2,
wherein the controller opens the valve on the dilution fuel circulation path, drives the circulation pump, and shuts off each valve on the first supply path and the second supply path for circulating the diluted fuel between the dilution fuel tank and the fuel cell.

8. The liquid circulation type fuel cell according to claim 1, wherein the fuel cell comprises:
an electrolyte membrane;
a fuel pole for supplying the diluted fuel on one side of the electrolyte membrane; and
an oxygen pole for supplying an oxidizing agent including oxygen on the other side of the electrolyte membrane.

9. The liquid circulation type fuel cell according to claim 8,
wherein the electrolyte membrane comprises a permeable membrane formed of a substance capable of permeating protons or electrons.

10. The liquid circulation type fuel cell according to claim 3,
wherein the controller drives the decompression mechanism at a predetermined period.

11. A control method for a liquid circulation type fuel cell comprising:
a step of circulating diluted fuel from a dilution fuel tank for retaining the diluted fuel having the liquid fuel mixed with water, to a fuel cell for generating power using liquid fuel, via a dilution fuel circulation path at least having a circulation pump;
a water and fuel supply step of supplying the water or the liquid fuel to the dilution fuel tank either from a water tank for retaining the water or a fuel tank for retaining the liquid fuel; and
a decompression step of reducing the pressure in the dilution fuel tank by means of a decompression mechanism for removing gas.

12. The control method for the liquid circulation type fuel cell according to claim 11,
wherein the decompression step comprises:
a step of shutting off valves respectively provided on the dilution fuel circulation path, a first supply path connecting the water supply tank with the dilution fuel tank, and a second supply path connecting the fuel supply tank with the dilution fuel tank; and
a step of driving the decompression mechanism.

13. The control method for the liquid circulation type fuel cell according to claim 12,
wherein the supply step comprises a step of supplying the water or the liquid fuel to the dilution fuel tank by opening either one of the valves on the first supply path and the second supply path, and driving the decompression mechanism.

14. The control method for the liquid circulation type fuel cell according to claim 13,
wherein the supply step comprises a step of supplying the water or the liquid fuel to the dilution fuel tank by detecting a fuel concentration in the dilution fuel tank, opening either one of the valves on the first supply path and the second supply path according to the detected concentration, and driving the decompression mechanism.

15. The control method for the liquid circulation type fuel cell according to claim 11,
wherein the decompression step comprises a step of controlling a decompression mechanism having a valve connected to the dilution fuel tank and a decompression pump connected to the valve.

16. The control method for the liquid circulation type fuel cell according to claim 12,
wherein the circulation step comprises:
a step of opening the valve on the dilution fuel circulation path;
a step of driving the circulation pump; and
a step of shutting off each valve on the first supply path and the second supply path.

17. The control method for the liquid circulation type fuel cell according to claim 11,
wherein the fuel cell comprises:
an electrolyte membrane;
a fuel pole supplying the diluted fuel on one side of the electrolyte membrane; and
an oxygen pole supplying an oxidizing agent including oxygen on the other side of the electrolyte membrane.

18. The control method for the liquid circulation type fuel cell according to claim 17,
wherein the electrolyte membrane comprises a permeable membrane formed of a substance capable of permeating protons or electrons.

19. The control method for the liquid circulation type fuel cell according to claim 11,
wherein the decompression step comprises the step of driving the decompression mechanism at a predetermined period.
